(19) United States
(12) Patent Application Publication
(10) Pub. No.: US 2026/0149053 A1
(43) Pub. Date: May 28, 2026

(54) NEGATIVE ELECTRODE FOR RECHARGEABLE LITHUM BATTERY AND RECHARGEABLE LITHIUM BATTERY INCLUDING THE SAME

(71) Applicant: SAMSUNG SDI CO., LTD., Yongin-si (KR)

(72) Inventors: JeongJoo PARK, Yongin-si (KR); Jin Seok PARK, Yongin-si (KR); Hyun NAM, Yongin-si (KR); Taeil LEE, Yongin-si (KR); Minho LEE, Yongin-si (KR); Fumiko KIMURA, Yongin-si (KR)

(73) Assignee: SAMSUNG SDI CO., LTD., Yongin-si (KR)

(21) Appl. No.: 19/178,210

(22) Filed: Apr. 14, 2025

(30) Foreign Application Priority Data
Apr. 15, 2024 (KR) 10-2024-0050025

(51) Int. Cl. H01M 10/42; H01M 4/02; H01M 4/133; H01M 4/134; H01M 4/38; H01M 4/583; H01M 10/0525

(52) U.S. Cl. CPC H01M 10/4235; H01M 4/133; H01M 4/134; H01M 4/386; H01M 4/583; H01M 10/0525; H01M 2004/021; H01M 2004/027

(57) ABSTRACT

Disclosed are negative electrodes and rechargeable lithium batteries including the same. The negative electrode includes a negative electrode current collector, and a negative electrode active material layer on the negative electrode current collector. The negative electrode active material layer includes a first active material layer, a second active material layer, and a third active material layer that are stacked on the negative electrode current collector. The second active material layer includes carbon and silicon. The negative electrode active material layer further includes a hole on a first portion of the negative electrode active material layer. The hole penetrates the third active material layer to expose the second active material layer. A floor of the hole is between top and bottom surfaces of the second active material layer.

### CROSS-REFERENCE TO RELATED APPLICATION

This U.S. nonprovisional application claims priority under 35 U.S.C § 119 to Korean Patent Application No. 10-2024-0050025 filed on Apr. 15, 2024 in the Korean Intellectual Property Office, the disclosure of which is hereby incorporated by reference in its entirety.

### BACKGROUND

The present disclosure relates to a negative electrode for a rechargeable lithium battery, and a rechargeable lithium battery including the negative electrode, and more particularly, to a multilayered negative electrode for a rechargeable lithium battery, and a rechargeable lithium battery including the multilayered negative electrode.

With increasing use of battery using electronic devices, such as, e.g., mobile phones, laptop computers, electric vehicles, and the like, there is an increasing demand for rechargeable batteries with high energy density and high capacity.

A rechargeable lithium battery typically includes a positive electrode, a negative electrode, and an electrolyte, the positive and negative electrodes including an active material in which intercalation and deintercalation are possible, and the battery generates electrical energy caused by oxidation and reduction reactions when lithium ions are intercalated and deintercalated.

### SUMMARY

An example embodiment of the present disclosure includes a negative electrode for a rechargeable lithium battery having a large capacity, a high charge/discharge rate, and stability.

An example embodiment of the present disclosure includes a rechargeable lithium battery having a large capacity, a high charge/discharge rate, and stability.

According to an example embodiment of the present disclosure, a negative electrode for a rechargeable lithium battery may include a negative electrode current collector, and a negative electrode active material layer on the negative electrode current collector. The negative electrode active material layer may include a first active material layer, a second active material layer, and a third active material layer that are stacked, e.g., sequentially stacked, on the negative electrode current collector. The second active material layer may include carbon and silicon. The negative electrode active material layer may further include a hole on a first, or upper, portion of the negative electrode active material layer. The hole may penetrate the third active material layer to expose the second active material layer. A floor of the hole may be between top and bottom surfaces of the second active material layer.

According to an example embodiment of the present disclosure, a negative electrode for a rechargeable lithium battery may include a negative electrode current collector, and a negative electrode active material layer on the negative electrode current collector. The negative electrode active material layer may include a first region and a second region adjacent to the first region. The first region may include a plurality of first holes on a first, or upper, portion of the first region. The second region may include a plurality of second holes on a first, or upper, portion of the second region. A first pitch of the first holes may be different from a second pitch of the second holes.

According to an example embodiment of the present disclosure, a rechargeable lithium battery may include the negative electrode discussed above, a positive electrode that includes a positive electrode current collector and a positive electrode active material layer on the positive electrode current collector, and a separator between the negative electrode and the positive electrode.

### BRIEF DESCRIPTION OF DRAWINGS

FIG. 1 illustrates a simplified conceptual diagram showing a rechargeable lithium battery according to an example embodiment of the present disclosure.

FIGS. 2 to 5 illustrate diagrams showing a rechargeable lithium battery according to example embodiments of the present disclosure.

FIG. 6 illustrates a cross-sectional view showing a rechargeable lithium battery according to an example embodiment of the present disclosure.

FIG. 7 illustrates an enlarged cross-sectional view showing section M of FIG. 6.

FIG. 8 illustrates a plan view showing a negative electrode active material layer according to an example embodiment of the present disclosure.

FIGS. 9 and 10 illustrate cross-sectional views showing a rechargeable lithium battery according to another example embodiment of the present disclosure.

FIGS. 11 and 12 illustrate cross-sectional views showing a method of manufacturing a negative electrode according to an example embodiment of the present disclosure.

FIG. 13 illustrates a graph showing capacities and capacity retention rates of coin cells according to Embodiments and Comparative Examples.

### DETAILED DESCRIPTION OF EMBODIMENTS

In order to sufficiently understand the configuration and effect of the present disclosure, some example embodiments of the present disclosure will be described with reference to the accompanying drawings. It should be noted, however, that the present disclosure is not limited to the following example embodiments, and may be implemented in various forms. Rather, the example embodiments are provided only to disclose the present disclosure and let those skilled in the art to fully know the scope of the present disclosure.

In this description, it will be understood that, when an element is referred to as being “on” another element, the element can be directly on the other element or intervening elements may be present between therebetween. In the drawings, thicknesses of some components are exaggerated for effectively explaining the technical contents. Like reference numerals refer to like elements throughout the specification.

Unless otherwise specially noted in this description, the expression of singular form may include the expression of plural form. In addition, unless otherwise specially noted, the phrase “A or B” may indicate “A but not B,” “B but not A,” and “A and B.” The terms “comprises/includes” and/or “comprising/including” used in this description do not exclude the presence or addition of one or more other components.

As used herein, the term “combination thereof” may refer to a mixture, a stack, a composite, a copolymer, an alloy, a blend, or a reaction product.

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

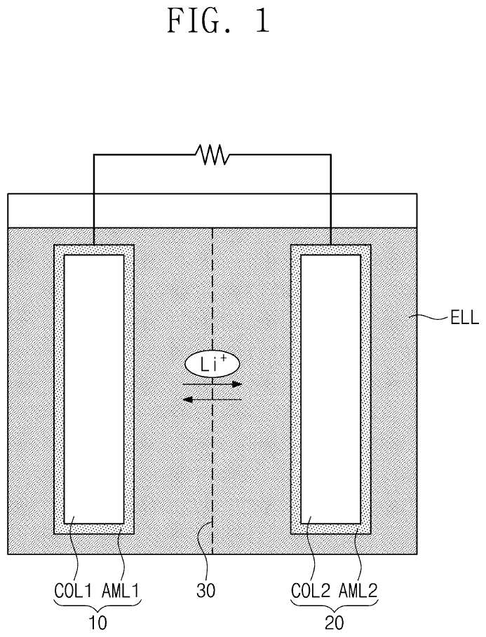

FIG. 1 illustrates a simplified conceptual diagram showing a rechargeable lithium battery according to an example embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and further include a binder and/or a conductive material.

For example, the positive electrode 10 may further include an additive that can constitute a sacrificial positive electrode.

An amount of the positive electrode active material may be about 90 wt % to about 99.5 wt % relative to 100 wt % of the positive electrode active material layer AML1. An amount of each of the binder and the conductive material may be about 0.5 wt % to about 5 wt % relative to 100 wt % of the positive electrode active material layer AML1.

The binder may improve attachment of positive electrode active material particles to each other and also to improve attachment of the positive electrode active material to the current collector COL1. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may provide an electrode with conductivity, and any suitable conductive material that does not cause chemical change of a battery may be used as the conductive material to constitute the battery. The conductive material may include, for example, a carbon-based material such as at least one of natural graphite, artificial graphite, carbon black, acetylene black, Ketjenblack, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is or includes at least one of cobalt, manganese, nickel, and a combination thereof.

The composite oxide may include lithium transition metal composite oxide, for example, at least one of lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by one of the chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LₐNiG_{b}O₂ (where 0.90<a<1.8 and 0.001<b<0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A is or includes at least one of Ni, Co, Mn, or a combination thereof, X is or includes at least one of Al, Ni, Co, Mn, Cr, Fe, Mg, Sr, V, a rare-earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

For example, the positive electrode active material may be or include a high nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material.

For example, the negative electrode active material layer AML2 may include a negative electrode active material of about 90 wt % to about 99 wt %, a binder of about 0.5 wt % to about 5 wt %, and a conductive material of about 0 wt % to about 5 wt %.

The binder may improve attachment of negative electrode active material particles to each other and also to improve attachment of the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is used as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may provide an electrode with conductivity, and any suitable conductive material that does not cause chemical change of a battery may be used as the conductive material to constitute the battery. For example, the conductive material may include a carbon-based material such as at least one of natural graphite, artificial graphite, carbon black, acetylene black, Ketjenblack, carbon fiber, carbon nano-fiber, and carbon nano-tube; a metal powder or metal fiber including one or more of copper, nickel, aluminum, and silver; a conductive polymer such as a polyphenylene derivative, or a mixture thereof.

The current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, or a transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as at least one of non-shaped, sheet-shaped, flake-shaped, sphere-shaped, or fiber-shaped natural or artificial graphite, and the amorphous carbon may include at least one of soft carbon, hard carbon, mesophase pitch carbon, or calcined coke.

The lithium metal alloy may include an alloy of lithium and metal that is or includes at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include at least one of silicon, silicon-carbon composite, SiOₓ (where 0<x<2), Si-Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO₂, a Sn-based alloy, a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) located on a surface of the secondary particle. The amorphous carbon may also be located between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer positioned on a surface of the core.

The Si-based negative electrode active material or the Sn-based negative electrode active material may be used in combination with a carbon-based negative electrode active material.

### Separator 30

Based on the type of rechargeable lithium battery, the separator 30 may be between positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, which coating layer includes an organic material, an inorganic material, or a combination thereof.

The porous substrate may be or include a polymer layer including a polyolefin having at least one of polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be or include a copolymer or mixture including two or more of the materials mentioned above.

The organic material may include a polyvinylidenefluoride-based copolymer or a (meth)acrylic copolymer.

The inorganic material may include an inorganic particle including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer, or may be configured as a stack including a coating layer including the organic material and a coating layer including an inorganic material.

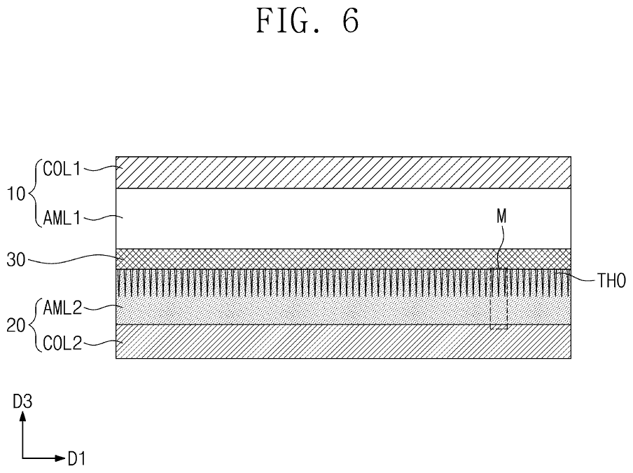

The negative electrode active material layer AML2 according to an example embodiment of the present disclosure will be further discussed in detail with reference to FIGS. 6 to 8.

### Electrolyte ELL

The electrolyte ELL for a rechargeable lithium battery may include at least one of a non-aqueous organic solvent and a lithium salt. The non-aqueous organic solvent may constitute a medium for transmitting ions that participate in an electrochemical reaction of a battery. The non-aqueous organic solvent may include a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include ethyl alcohol or isopropyl alcohol. The aprotic solvent may include nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be used alone or in a mixture of two or more substances.

In addition, when a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be or include a material that is dissolved in the non-aqueous organic solvent to constitute a supply source of lithium ions in a battery and plays a role in enabling a basic operation of a rechargeable lithium battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(CyF_{2y+1}SO₂) (where x and y are integers between 1 to 20), lithium trifluoromethane sulfonate, lithium tetrafluoroethanesulfonate, lithium difluorobis(oxalato)phosphate (LiDFBOP), and lithium bis(oxalato)borate (LiBOB)

### Rechargeable Lithium Battery

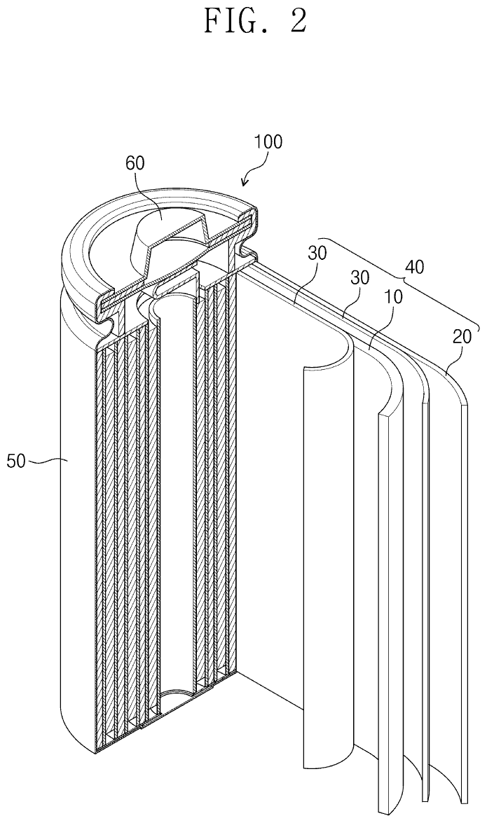

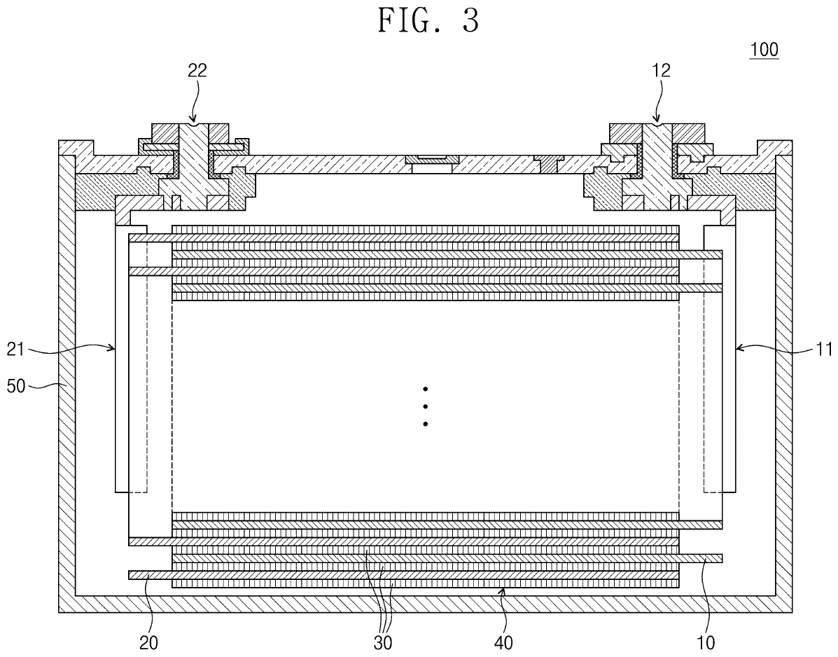

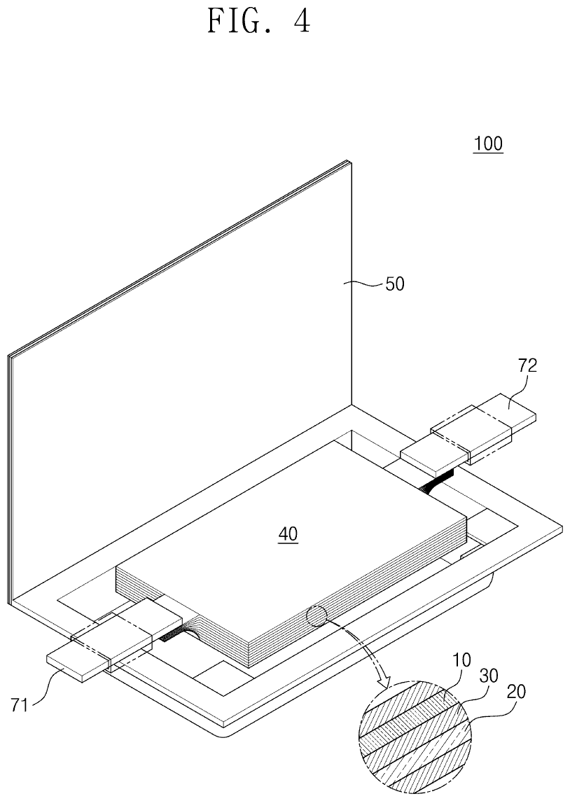

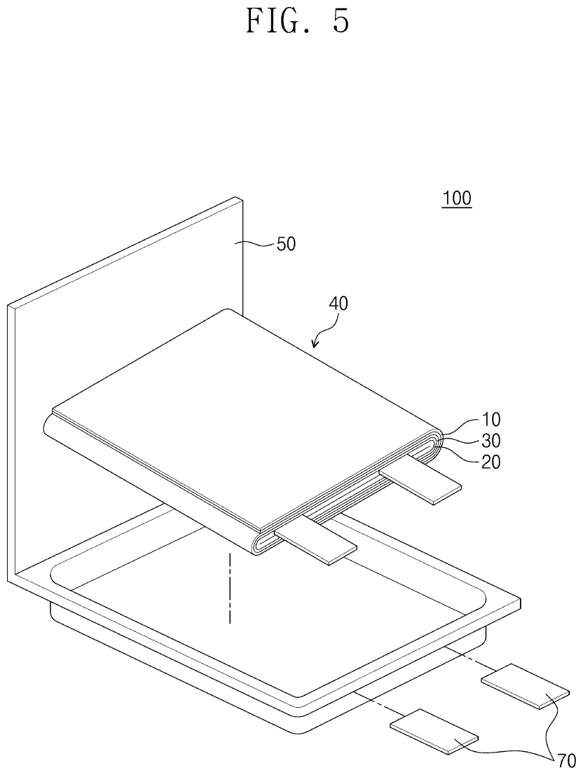

Based on the shape of a rechargeable lithium battery, the rechargeable lithium battery may be classified into cylindrical, prismatic, pouch, and coin types. In FIGS. 2 to 5 illustrating simplified diagrams showing a rechargeable lithium battery according to example embodiments, FIG. 2 shows a cylindrical battery, FIG. 3 shows a prismatic battery, and FIGS. 4 and 5 show pouch-type batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70 illustrated in FIG. 5, or a positive electrode tab 71 and a negative electrode tab 72 illustrated in FIG. 4, the electrode tabs 70/71/72 constituting an electrical path for externally inducing a current generated in the electrode assembly 40 to outside of the battery 100.

The following description will focus on a rechargeable lithium battery according to an example embodiment of the present disclosure.

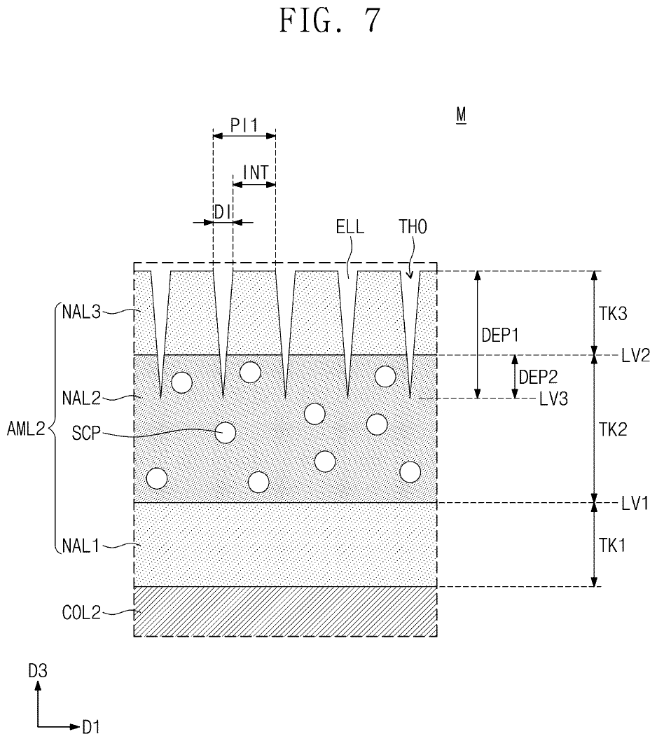

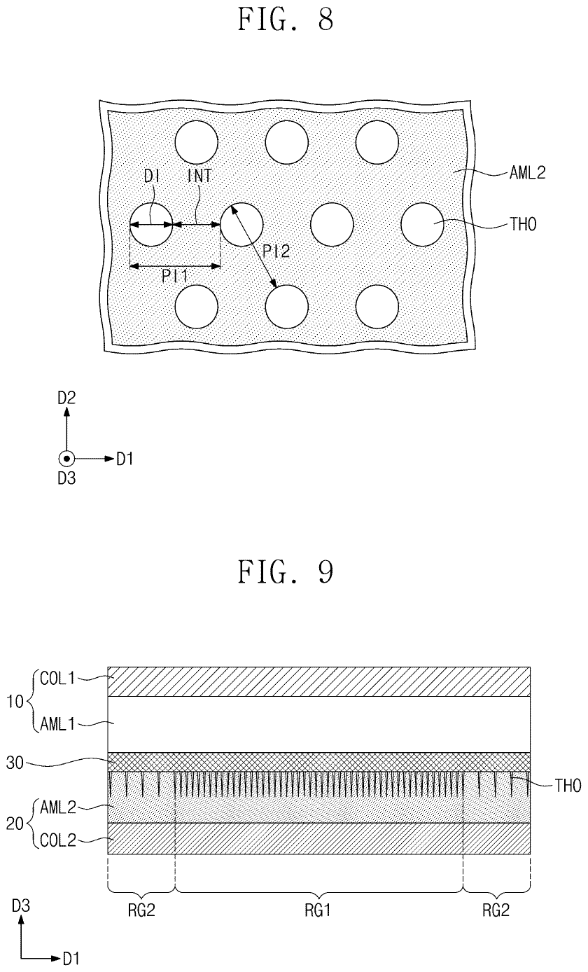

FIG. 6 illustrates a cross-sectional view showing a rechargeable lithium battery according to an example embodiment of the present disclosure. FIG. 7 illustrates an enlarged cross-sectional view showing section M of FIG. 6. FIG. 8 illustrates a plan view showing a negative electrode active material layer according to an example embodiment of the present disclosure.

Referring to FIG. 6, as discussed above with reference to FIG. 1, a rechargeable lithium battery according to the present disclosure may include a positive electrode 10, a negative electrode 20, and a separator 30 between the positive electrode 10 and the negative electrode 20. Although not clearly shown in FIG. 6, the rechargeable lithium battery according to the present disclosure may further include an electrolyte ELL. The separator 30 may be impregnated in the electrolyte ELL.

The positive electrode 10 may include a positive electrode current collector COL1 and a positive electrode active material layer AML1 on the positive electrode current collector COL1. The negative electrode 20 may include a negative electrode current collector COL2 and a negative electrode active material layer AML2 on the negative electrode current collector COL2. The separator 30 may be interposed between the positive electrode active material layer AML1 and the negative electrode active material layer AML2.

The negative electrode active material layer AML2 may include a plurality of holes THO formed on a first, or upper, portion thereof. In examples, the first, or upper, portion of the negative electrode active material layer AML2 is the portion thereof adjacent to the separator 30. Each, or one or more, of the plurality of holes THO may extend from a top surface of the negative electrode active material layer AML2 toward a bottom surface of the negative electrode active material layer AML2. The top surface of the negative electrode active material layer AML2 is the surface thereof adjacent to the separator 30, and the bottom surface of the negative electrode active material layer AML2 is the surface thereof adjacent to the negative electrode current collector COL2. The top surface of the negative electrode active material layer AML2 may be adjacent to or in contact with the separator 30. For example, the plurality of holes THO may be adjacent to the separator 30. The electrolyte ELL may fill the plurality of holes THO.

Referring to FIG. 7, the negative electrode active material layer AML2 according to an example embodiment of the present disclosure may have a multilayered structure. For example, the negative electrode active material layer AML2 may include a first active material layer NAL1, a second active material layer NAL2, and a third active material layer NAL3 that are stacked together, e.g., sequentially stacked. The first active material layer NAL1 may be directly on, and in contact with, the negative electrode current collector COL2. The second active material layer NAL2 may be interposed between the first active material layer NAL1 and the third active material layer NAL3.

The first to third active material layers NAL1 to NAL3 may include negative electrode active materials that are different from each other. The first to third active material layers NAL1 to NAL3 may have compositions that are different from each other. Each, or one or more, of the first to third active material layers NAL1 to NAL3 may include a carbon-based negative electrode active material, such as crystalline carbon, amorphous carbon, or any combination thereof. A detailed description thereof may be the same as the description of the negative electrode active material.

The first active material layer NAL1 may include a first crystalline carbon. The second active material layer NAL2 may include a second crystalline carbon and a silicon-containing particle SCP. The third active material layer NAL3 may include a third crystalline carbon. Each of the first to third crystalline carbons may be or include natural graphite, artificial graphite, or any mixture thereof.

In an example embodiment, in the first crystalline carbon of the first active material layer NAL1, natural graphite may have a proportion of about 0 wt % to about 100 wt %, about 50 wt % to about 100 wt %, or about 80 wt % to about 100 wt %. In the first crystalline carbon of the first active material layer NAL1, the proportion of natural graphite may be greater than the proportion of artificial graphite. In an example embodiment, in the third crystalline carbon of the third active material layer NAL3, artificial graphite may have a proportion of about 0 wt % to about 100 wt %, about 50 wt % to about 100 wt %, or about 80 wt % to about 100 wt %. In the third crystalline carbon of the third active material layer NAL3, the proportion of artificial graphite may be greater than the proportion of natural graphite. For example, the first active material layer NAL1 may include natural graphite, the third active material layer NAL3 may include artificial graphite, and the second active material layer NAL2 may include a mixture of natural graphite and artificial graphite.

In another example embodiment of the present disclosure, the second active material layer NAL2 may include no second crystalline graphite. The second active material layer NAL2 may include amorphous carbon and a silicon particle. The second active material layer NAL2 may include a silicon-carbon composite as the silicon-containing particle SCP which will be discussed below.

The second active material layer NAL2 may contain carbon (C) and silicon (Si). The silicon (Si) may originate from the silicon-containing particle SCP. The carbon (C) may originate from at least one of crystalline carbon, amorphous carbon, and carbon in the silicon-containing particle SCP.

The silicon (Si) in the second active material layer NAL2 may have a proportion of about 5 wt % to about 99 wt %, about 5 wt % to about 30 wt %, or about 5 wt % to about 10 wt %. The silicon-containing particle SCP may include at least one of silicon, silicon-carbon composite, SiOₓ (where 0<x<2), Si-Q alloy (where Q is alkali metal, alkaline earth metal, Group 13 element, Group 14 element (except for Si), Group 15 element, Group 16 element, transition metal, a rare-earth element, or any combination thereof), or any combination thereof.

Each, or at least one, of the first to third active material layers NAL1 to NAL3 may further include a binder. The binder in each, or at least one, of the first to third active material layers NAL1 to NAL3 may have an amount of about 1 wt % to about 10 wt %. In an example embodiment of the present disclosure, the binder of the second active material layer NAL2 including the silicon-containing particle SCP may have an amount greater than an amount of the binder of each of the first and third active material layers NAL1 and NAL3 including only crystalline carbon. A large amount of binder in an active material layer may cause a reduction in movement speed of lithium ions.

The first active material layer NAL1 may have a first thickness TK1, the second active material layer NAL2 may have a second thickness TK2, and the third active material layer NAL3 may have a third thickness TK3. In an example embodiment of the present disclosure, the second thickness TK2 may be greater than the first thickness TK1. The second thickness TK2 may be greater than the third thickness TK3.

As the second active material layer NAL2 includes the silicon-containing particle SCP, the second active material layer NAL2 may have an increased volume during charge of the rechargeable lithium battery. For example, the second thickness TK2 of the second active material layer NAL2 may increase when the rechargeable lithium battery is charged. However, the first active material layer NAL1 and the third active material layer NAL3 formed of or including only crystalline carbon may have no large variation in volume (or thickness). This may be caused by the fact that, when the battery is charged, the silicon-containing particle SCP intercalates lithium ions more than crystalline carbon. During charge/discharge of the rechargeable lithium battery, the first active material layer NAL1 and the third active material layer NAL3 may constitute a buffer layer to reduce a variation in volume (or thickness) of the second active material layer NAL2.

According to an example embodiment of the present disclosure, the hole THO of the negative electrode active material layer AML2 may penetrate the third active material layer NAL3. The hole THO may have a first depth DEP1. The first depth DEP1 may be greater than the third thickness TK3. As the hole THO substantially completely penetrates the third active material layer NAL3, the hole THO may cause a reduction in volume of the third active material layer NAL3, and thus the third active material layer NAL3 may have a reduced capacity.

A floor of the hole THO may be positioned between top and bottom surfaces of the second active material layer NAL2. The hole THO may not penetrate the second active material layer NAL2. For example, the bottom surface of the second active material layer NAL2 may be located at a first level LV1, and the top surface of the second active material layer NAL2 may be located at a second level LV2. The floor of the hole THO may be located at a third level LV3. The third level LV3 may be between the first level LV1 and the second level LV2.

The hole THO may be filled with the electrolyte ELL. The second active material layer NAL2 may be in contact with the electrolyte ELL through the hole THO. As the second active material layer NAL2 is in contact with the electrolyte ELL through the hole THO, there may be an increase in movement speed of lithium ions of the second active material layer NAL2 even though the second active material layer NAL2 has a relatively large amount of the binder.

Referring to FIG. 8, the plurality of holes THO may be arranged at a first pitch PI1 in a first direction D1. Each of the plurality of holes THO may have a first diameter D1. A first distance INT may be provided as an interval between neighboring holes THO. The first pitch PI1 may be a sum of the first diameter D1 and the first distance INT. In an example embodiment, the first distance INT may be greater than the first diameter D1. A second pitch PI2 may be given between the holes THO that are diagonally adjacent to each other among the plurality of holes THO. The second pitch PI2 may be the same as or greater than the first pitch PI1.

FIG. 8 shows by way of example that the hole THO has a circular planar shape. The arrangement and planar shape of the holes THO are, however, not limited to the arrangement and shape illustrated in FIG. 8. For example, the hole THO may have an oval planar shape or a polygonal planar shape, but the present disclosure is not especially limited thereto.

Referring back to FIG. 7, in an example embodiment, a second depth DEP2 of the hole THO may be defined between the second level LV2 and the third level LV3. A ratio (DEP2/TK2) of the second depth DEP2 to the second thickness TK2 may range from about 0.1 to about 0.8 or from about 0.2 to about 0.5. When the ratio (DEP2/TK2) is less than about 0.2, there may be a reduction in movement speed of lithium ions of the second active material layer NAL2, and therefore this may induce a decrease in charge/discharge rate of the battery. When the ratio (DEP2/TK2) is greater than about 0.5, the first diameter D1 of the hole THO may become greater than the first distance INT, and therefore this may weaken the structural stability of the negative electrode active material layer AML2. When the ratio (DEP2/TK2) is greater than about 0.5, the hole THO may cause a reduction in volume of the second active material layer NAL2, and therefore the negative electrode active material layer AML2 may have a reduced capacity.

According to an example embodiment of the present disclosure, a ratio (D1/PI1) of the first diameter D1 to the first pitch PI1 may range from about 0.1 to about 0.4. When the ratio (D1/PI1) is less than about 0.1, the first depth DEP1 of the hole THO may not be formed sufficiently deep enough to penetrate the third active material layer NAL3. When the ratio (D1/PI1) is greater than about 0.4, a size of the hole THO may become excessively large to weaken the structural stability of the negative electrode active material layer AML2. When the ratio (D1/PI1) is greater than about 0.4, the hole THO may cause a reduction in volume of the second active material layer NAL2, and therefore the negative electrode active material layer AML2 may have a reduced capacity.

As discussed above, the negative electrode active material layer AML2 according to the preset disclosure may include a plurality of holes THO by which the second active material layer NAL2 including a silicon-based active material is exposed to the electrolyte ELL. The plurality of holes THO may structurally mitigate a variation in volume of the second active material layer NAL2, and may also reduce a migration path of lithium ions between the second active material layer NAL2 and the electrolyte ELL. As a result, even though the second active material layer NAL2 has a relatively large amount of a binder, there may be an increase in movement speed of lithium ions of the second active material layer NAL2. The rechargeable lithium battery according to the present disclosure may have an increased capacity and an improved charge/discharge rate.

As the ratio (DEP2/TK2) is defined ranging from about 0.1 to about 0.8 or from about 0.2 to about 0.5, a reduction in volume of the second active material layer NAL2 due to the plurality of holes THO may not be significant. Therefore, the plurality of holes THO according to the present disclosure may induce a significant increase in charge/discharge rate of the rechargeable lithium battery, and may not cause a significant reduction in battery capacity.

In the example embodiments that follow, a detailed description of technical features repetitive to those of the rechargeable lithium battery discussed above with reference to FIGS. 6 to 8 will be omitted, and a difference thereof will be discussed in detail.

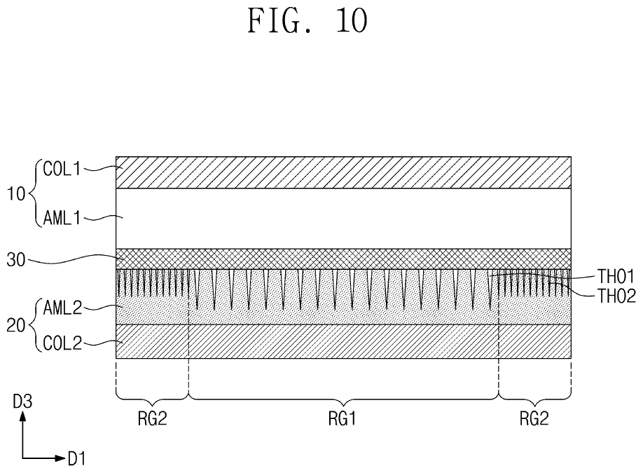

FIGS. 9 and 10 illustrate cross-sectional views showing a rechargeable lithium battery according to another example embodiment of the present disclosure. Referring to FIG. 9, the negative electrode active material layer AML2 may include a first region RG1 and a second region RG2. According to an example embodiment of the present disclosure, the second region RG2 may be or include a side area of the negative electrode active material layer AML2. The first region RG1 may be or include a central area of the negative electrode active material layer AML2.

A density of the holes THO in the first region RG1 may be different from the density of the holes THO in the second region RG2. In this sense, a pitch between the holes THO in the first region RG1 may be different from the pitch between the holes THO in the second region RG2. For example, the density (or pitch) of the holes THO in the first region RG1 may be greater than the density (or pitch) of the holes THO in the second region RG2. In an example embodiment, a ratio of the pitch of the holes THO in the first region RG1 to the pitch of the holes THO in the second region RG2 may range from about 1.5 to about 10.

In an example embodiment, the first region RG1 of the negative electrode active material layer AML2 may be or include an area where a reaction with lithium ions actively occurs. Compared to the first region RG1, the second region RG2 may have a large effect on structural stability of the battery than on a reaction with lithium ions. Thus, the first region RG1 may increase a density of the holes THO to improve reactivity with lithium ions, and the second region RG2 may reduce a density of the holes THO to improve stability of the battery.

Referring to FIG. 10, the negative electrode active material layer AML2 may include a first region RG1 and a second region RG2. According to an example embodiment of the present disclosure, the second region RG2 may be or include a side area of the negative electrode active material layer AML2. The first region RG1 may be or include a central area of the negative electrode active material layer AML2. The first region RG1 may include first holes THO1. The second region RG2 may include second holes THO2.

The first hole THO1 may have a different depth from the depth of the second hole THO2. In an example embodiment, the depth of the first hole THO1 may be greater than the depth of the second hole THO2. The first hole THO1 may have a diameter greater than the diameter of the second hole THO2. In an example embodiment, a ratio of the depth of the first hole THO1 to the depth of the second hole THO2 may range from about 1.1 to about 2. A ratio of the diameter of the first hole THO1 to the diameter of the second hole THO2 may range from about 1.3 to about 4.

As discussed above, the first region RG1 of the negative electrode active material layer AML2 may be or include an area where a reaction with lithium ions actively occurs. Compared to the first region RG1, the second region RG2 may have a large effect on structural stability of the battery than on a reaction with lithium ions. Thus, on the first region RG1, an increase in diameter and depth of the first hole THO1 may improve the reaction with lithium ions. On the second region RG2, a reduction in diameter and depth of the second hole THO2 may improve battery stability.

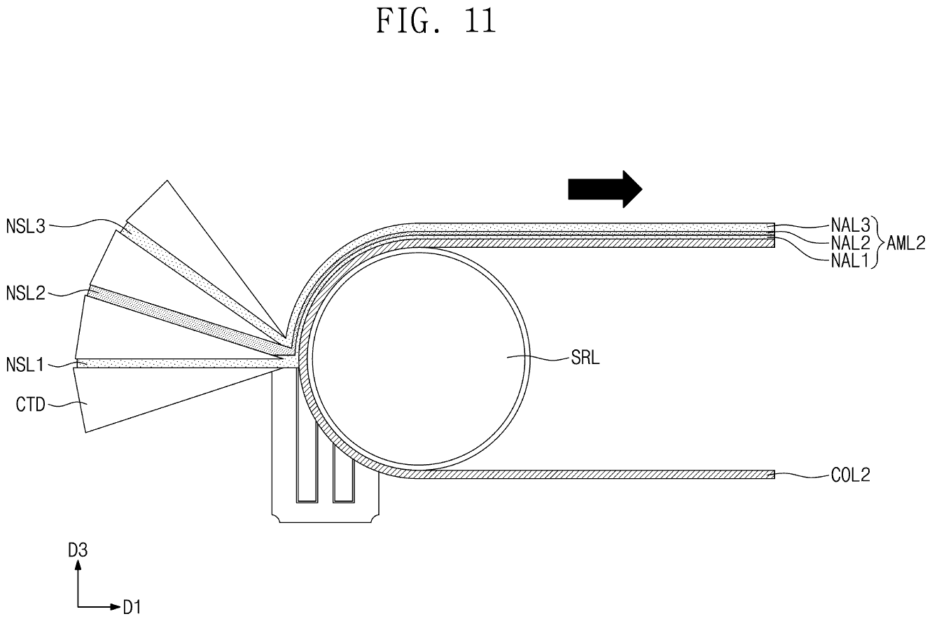

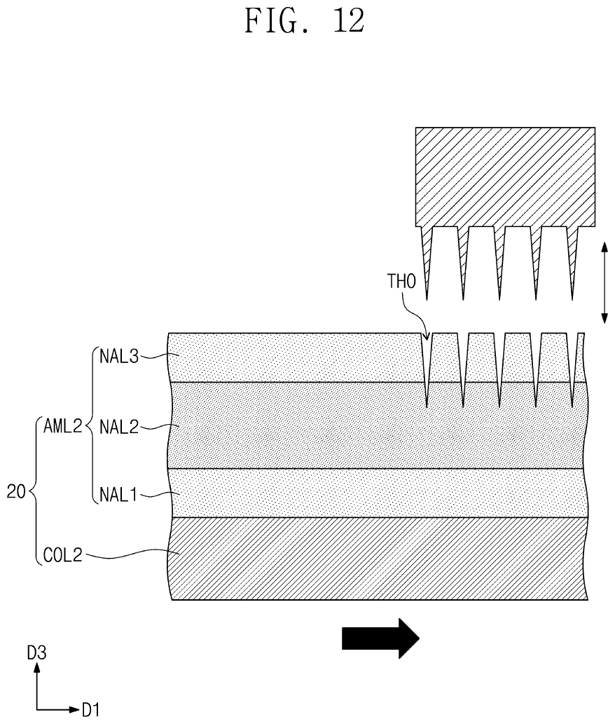

FIGS. 11 and 12 illustrate cross-sectional views showing a method of manufacturing a negative electrode according to an example embodiment of the present disclosure.

Referring to FIG. 11, a wound negative electrode current collector COL2 may be unwrapped and fed into a coating process. The traveling negative electrode current collector COL2 may be transported and coated in a first direction D1 by a supporting roll SRL. On the supporting roll SRL, the negative electrode current collector COL2 may undergo a coating process.

A coating die CTD may be disposed adjacent to the supporting roll SRL. The coating die CTD may include three holes for slurry injection. The three slurry injection holes may be provided with a first negative electrode slurry NSL1, a second negative electrode slurry NSL2, and a third negative electrode slurry NSL3. The coating die CTD may be configured such that the first negative electrode slurry NSL1, the second negative electrode slurry NSL2, and the third negative electrode slurry NSL3 are sequentially coated on the negative electrode current collector COL2.

For example, the first negative electrode slurry NSL1 may include a first crystalline carbon, a binder, and a solvent. The second negative electrode slurry NSL2 may include a second crystalline carbon, a silicon-containing particle, a binder, and a solvent. The third negative electrode slurry NSL3 may include a third crystalline carbon, a binder, and a solvent. Each of the first to third crystalline carbons may be or include natural graphite, artificial graphite, or any mixture thereof. For example, the first negative electrode slurry NSL1 may include natural graphite. The third negative electrode slurry NSL3 may include artificial graphite.

The solvent in the slurry may be or include a commonly used solvent in the art, for example, may include at least one of dimethyl sulfoxide (DMSO), isopropyl alcohol, N-methyl pyrrolidone (NMP), acetone, water, and a combination thereof.

The first negative electrode slurry NSL1, the second negative electrode slurry NSL2, the third negative electrode slurry NSL3 coated on the negative electrode current collector COL2 may be dried to respectively form a first active material layer NAL1, a second active material layer NAL2, and a third active material layer NAL3 that are discussed above with reference to FIG. 6. A negative electrode active material layer AML2 may be constituted by the first active material layer NAL1, the second active material layer NAL2, and the third active material layer NAL3 that are stacked, e.g., sequentially stacked, on the negative electrode current collector COL2.

Referring to FIG. 12, a hole process may be performed on the negative electrode active material layer AML2. A plurality of holes THO may be formed on a first, or upper, portion of the negative electrode active material layer AML2. For example, the hole THO may be formed to have a depth that penetrates the third active material layer NAL3, but does not penetrate the second active material layer NAL2. The hole process may be, e.g., continuously performed while moving a negative electrode 20 in the first direction D1.

In an example embodiment, as shown in FIG. 12, the hole THO may be physically formed using a punching machine in which a fine needle is formed. In another example embodiment, the hole THO may be formed by laser. Various factors, such as the degree of active material detachment during process, the degree of unintended side reactions, the shape of holes, and the process speed, may be considered to select a process using a laser or a punching machine.

Afterwards, the negative electrode 20 may, undergo, e.g., sequentially undergo, at least one of a roll-pressing process, a slitting process, and a notching process. The negative electrode 20, a separator 30, and a positive electrode 10 may be stacked, and an electrolyte ELL may subsequently be provided to fabricate a rechargeable lithium battery according to the present disclosure.

The following description will focus on some example embodiments of the present disclosure. The following example embodiments are provided to aid in understanding of the present disclosure and are not intended to limit the scope of the present disclosure.

### Manufacture of Negative Electrode

98 wt % of natural graphite, 0.8 wt % of carboxymethyl cellulose, and 1.2 wt % of styrene-butadiene rubber were mixed in pure water to prepare a first negative electrode slurry. 32.25 wt % of natural graphite, 32.25 wt % of artificial graphite, 30 wt % of silicon nano-particles, 1.5 wt % of carboxymethyl cellulose, and 4 wt % of styrene-butadiene rubber were mixed in pure water to prepare a second negative electrode slurry. 98 wt % of artificial graphite, 0.8 wt % of carboxymethyl cellulose, and 1.2 wt % of styrene-butadiene rubber were mixed in pure water to prepare a third negative electrode slurry.

The first negative electrode slurry, the second negative electrode slurry, and the third negative electrode slurry were sequentially coated on a copper current collector. A first drying process was performed at 80° C., and a roll-pressing process was subsequently performed. A multi-layered negative electrode active material layer underwent a hole process using a punching machine to form holes. Subsequently, a second drying process was performed at 120° C. under vacuum environment.

A negative electrode of Embodiment 1 was prepared by processing a hole such that the ratio (DEP2/TK2) shown in FIG. 7 reached 0.2. A negative electrode of Embodiment 2 was prepared by processing a hole such that the ratio (DEP2/TK2) reached 0.5. A negative electrode of Embodiment 3 was prepared by processing a hole such that the ratio (DEP2/TK2) reached 0.5 on a central portion of the negative electrode and 0.2 on a side portion of the negative electrode (see FIG. 10). A negative electrode of Embodiment 4 was prepared by processing holes such that a first pitch between the holes on a central portion of the negative electrode was less than the pitch between the holes on a side portion of the negative electrode (see FIG. 9).

A negative electrode of Comparative Example 1 was prepared by omitting the hole process. A negative electrode of Comparative Example 2 was prepared by processing a hole such that the ratio (DEP2/TK2) reached 0.1. A negative electrode of Comparative Example 3 was prepared by processing a hole such that the ratio (DEP2/TK2) reached 0.7. A negative electrode of Comparative Example 4 was prepared by shallowly processing a hole to expose only the third active material layer (see NAL3 of FIG. 7). A negative electrode of Comparative Example 5 was prepared by deeply processing a hole to expose only the first active material layer (see NAL1 of FIG. 7).

### Fabrication of Half Cell

A prepared negative electrode was wound into a circular shape with a diameter of 12 mm, and a 2032-type coin half-cell was subsequently fabricated with lithium metal as a counter electrode. An organic electrolyte was used in which 1.3M LiPF₆ was dissolved in a mixture solvent containing ethylene carbonate, diethyl carbonate, and fluoroethylene carbonate mixed in a weight ratio of 2:6:2.

### Fabrication of Full Cell

96 grams of LiNi_{0.6}Co_{0.2}Mn_{0.2}O₂ as a positive electrode active material, 2 grams of polyvinylidene fluoride, 47 grams of N-methyl pyrrolidone as a solvent, and 2 grams of carbon black as a conductive material were mixed to prepare a positive electrode slurry. A doctor blade was used to coat the positive electrode slurry on an aluminum current collector to manufacture a positive electrode. The positive electrode was dried at 135° C. for 3 hours or more, and subsequently roll-pressed and vacuum dried.

The manufactured negative electrode, polytetrafluoroethylene (PTFE), a separator, and the positive electrode were stacked to fabricate a rechargeable lithium battery. 1.3M LiPF₆, dissolved in a mixture solvent containing ethylene carbonate (EC), ethylmethyl carbonate (EMC), and diethyl carbonate (DEC) mixed in a volume ratio of 3:5:2, was used as an electrolyte to fabricate a CR2032-type coin full-cell.

### Evaluation 1: Specific Capacity Characteristics of Half Cells and Rapid Charge Characteristics of Rechargeable Lithium Batteries

The coin half-cells using the negative electrodes according to Embodiments 1 to 4 and Comparative Examples 1 to 5 were 0.2 C, 0.01V cut-off charged under the condition of constant current, 0.05 C cut-off charged under the condition of constant voltage, and 0.2 C, 1.5V cut-off discharged under the condition of constant current. A discharge capacity at the first charge/discharge was obtained to evaluate specific capacity characteristics of the half cell, and the results are listed in Table 1 below.

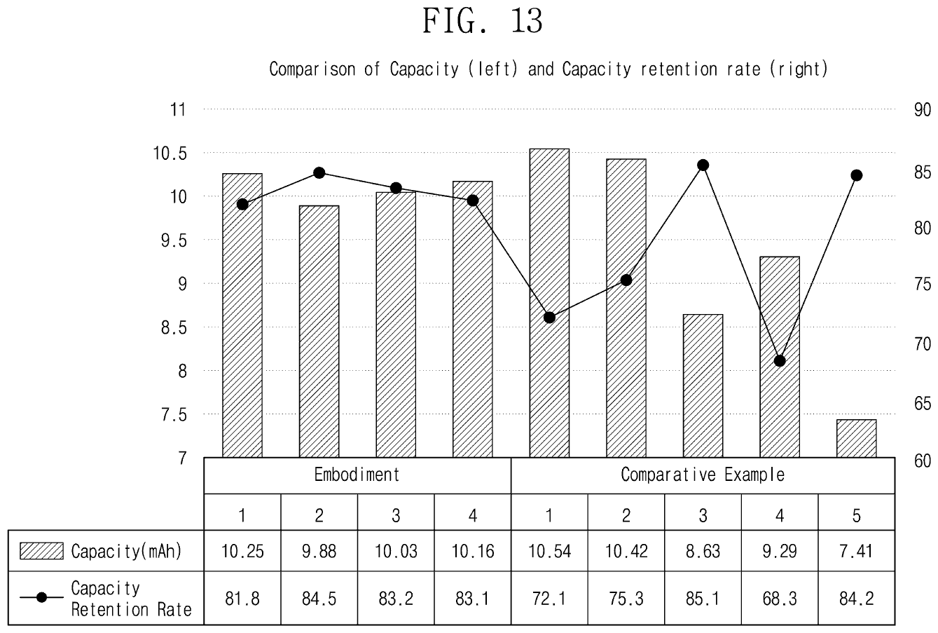

The coin full-cells using the negative electrodes according to Embodiments 1 to 4 and Comparative Examples 1 to 5 were once charged and discharged in which 0.2 C, 4.4V cut-off charged under the condition of constant current, 0.05 C cut-off charged under the condition of constant voltage, and 2.45V cut-off discharged under the condition of constant current, and subsequently charged for 30 minutes at 2.0 C, 4.4V cut-off under the condition of constant current and 0.05 C cut-off under the condition of constant voltage. Thereafter, the coin full-cells were 0.2 C, 3.0V cut-off discharged under the condition of constant current. From the measurement results, a ratio of the charge capacity at the second charge/discharge to the charge capacity at the first charge/discharge was calculated to obtain a 30-minute rapid charge rate (%), and the results are listed in Table 1 below and FIG. 13.

TABLE 1

| | | | Specific capacity | |
|---|---|---|---|---|
| | | | (discharge | 30-minute rapid |
| | | | capacity at | charge rate (2^{nd} |
| | | | 0.2 C, 1^{st} | charge amount/1^{st} |
| | Hole depth | Hole diameter | charge/discharge) | charge amount) |
| | (DEP2/TK2) | (DI/PI1) | (mAh/g) | (%) |
| Embodiment 1 | 0.2 | 0.2 | 10.25 | 81.8 |
| Embodiment 2 | 0.5 | 0.4 | 9.88 | 84.5 |
| Embodiment 3 | RG1: 0.5 | RG1: 0.4 | 10.03 | 83.2 |
| | RG2: 0.2 | RG2: 0.2 | | |
| Embodiment 4 | RG1: 0.2 | RG1: 0.2 | 10.16 | 82.1 |
| | RG2: 0.2 | RG2: 0.2 | | |
| | (1^{st} pitch between holes of | | | |
| | RG1 is less than 2^{nd} pitch | | | |
| | between holes of RG2) | | | |
| Comparative | 0 | 0 | 10.54 | 72.1 |
| Example 1 | | | | |
| Comparative | 0.1 | 0.1 | 10.42 | 75.3 |
| Example 2 | | | | |
| Comparative | 0.7 | 0.6 | 8.63 | 85.1 |
| Example 3 | | | | |
| Comparative | — | 0.1 | 9.29 | 68.3 |
| Example 4 | | | | |
| Comparative | — | 1.0 | 7.41 | 84.2 |
| Example 5 | | | | |

Referring to Table 1 and FIG. 13, it may be ascertained that Comparative Example 1 has an extremely low rapid charge rate due to an absence of the holes in the negative electrode. It can be determined that the negative electrode of Comparative Example 2 did not substantially contribute to movement speed of lithium ions due to the relatively small depth and diameter of the hole. It may be ascertained that the negative electrode of Comparative Example 3 exhibits an improved or desired rapid charge rate due to relatively large depth and diameter of the hole, but has a greatly reduced specific capacity due to an increase in size of the hole. It is observed that the negative electrode of Comparative Example 4 had an extremely low rapid charge rate, and that the negative electrode of Comparative Example 5 has a significantly reduced specific capacity.

In contrast, it may be observed that each of the negative electrodes of Embodiments 1 to 4 has both an improved or desired specific capacity, and a substantially rapid charge rate. In conclusion, it may be ascertained that when a rechargeable battery includes a hole having a desired size and depth as discussed above with respect to Embodiments 1 to 4, both a high specific capacity of the negative electrode and an improved movement speed of lithium ions are achieved to allow the rechargeable battery to have a rapid charge/discharge rate.

### Evaluation 2: Physical Stability

The coin full-cells using the negative electrodes according to Embodiment 1 to 3 and Comparative Example 1 to 3 have undergone a test of penetration, drop, and impact. Table 2 below lists results of physical stability evaluation. Table 3 below shows criteria of physical stability evaluation.

TABLE 2

| | | Hole | | | |
|---|---|---|---|---|---|
| | Hole depth | diameter | | | |
| | (DEP2/TK2) | (DI/PI1) | Penetration | Drop | Impact |
| Embodiment 1 | 0.2 | 0.2 | L2 | L2 | L2 |
| Embodiment 2 | 0.5 | 0.4 | L2 | L2 | L2 |
| Comparative | 0 | 0 | L1 | L1 | L1 |
| Example 1 | | | | | |
| Comparative | 0.1 | 0.1 | L2 | L2 | L2 |
| Example 2 | | | | | |
| Comparative | 0.7 | 0.6 | L5 | L4 | L5 |
| Example 3 | | | | | |

TABLE 3

| Criteria Level | Criterion |
|---|---|
| L0 | No abnormal |
| L1 | Leak, External Temperature <150° C. |
| L2 | External Temperature <200° C. |
| L3 | Smoke, External Temperature >200° C. |
| L4 | Flame |
| L5 | Explosion |

Referring to Table 2 and Table 3, in the case of the rechargeable lithium batteries using the negative electrodes of Embodiment 1 and Embodiment 2, it may be expected that ion channels are effectively reduced or suppressed during thermal runaway caused by physical impact, and that a shut-down function may be achieved early. In addition, the rechargeable lithium battery using the negative electrode of Comparative Example 3 is vulnerable to external impact. It may be ascertained that an excessive increase in depth and diameter of the hole of the negative electrode active material layer may have a negative effect on battery stability.

A negative electrode for a rechargeable lithium battery according to the present disclosure may achieve a high capacity through a silicon-containing active material layer, and may reduce a variation in volume of the silicon active material layer though an adjacent buffer layer (carbon layer). Moreover, movement speeds of lithium ions may be increased through a hole configured to allow the active material layer to contact an electrolyte. As a result, the rechargeable lithium battery according to the present disclosure may have an improved or desired capacity and a superior charge/discharge rate.

While this disclosure has been described in connection with what is presently considered to be example embodiments, it is to be understood that the present disclosure is not limited to the disclosed example embodiments and is intended to cover various modifications and equivalent arrangements included within the spirit and scope of the appended claims, and therefore the aforementioned example embodiments should be understood to not limit this disclosure in any way.

What is claimed is:

1. A negative electrode for a rechargeable lithium battery, the negative electrode comprising:
a negative electrode current collector; and
a negative electrode active material layer on the negative electrode current collector;
wherein the negative electrode active material layer includes a first active material layer, a second active material layer, and a third active material layer that are stacked on the negative electrode current collector;
wherein the second active material layer includes carbon and silicon;
wherein the negative electrode active material layer further includes a hole on a first portion of the negative electrode active material layer;
wherein the hole penetrates the third active material layer to expose the second active material layer; and
wherein a floor of the hole is between top and bottom surfaces of the second active material layer.

2. The negative electrode of claim 1, wherein:
the first active material layer and the third active material layer comprise a first crystalline carbon and a third crystalline carbon, respectively;
a proportion of natural graphite in the first crystalline carbon is greater than a proportion of artificial graphite in the first crystalline carbon; and
a proportion of artificial graphite in the third crystalline carbon is greater than a proportion of natural graphite in the third crystalline carbon.

3. The negative electrode of claim 1, wherein:
an amount of a binder in the second active material layer is greater than an amount of the binder in the first active material layer, and
the amount of the binder in the second active material layer is greater than an amount of the binder in the third active material layer.

4. The negative electrode of claim 1, wherein a proportion of the silicon in the second active material layer is in a range of about 5 wt % to about 10 wt %.

5. The negative electrode of claim 1, wherein:
the bottom surface of the second active material layer is at a first level;
the top surface of the second active material layer is at a second level;
the floor of the hole is at a third level;
a depth of the hole is defined between the second level and the third level; and
a ratio of the depth of the hole to a thickness of the second active material layer is in a range of about 0.2 to about 0.5.

6. The negative electrode of claim 1, wherein:
the hole comprises a plurality of holes;
the plurality of holes are arranged at a first pitch;
at least one of the plurality of holes has a first diameter; and
a ratio of the first diameter to the first pitch is in a range of about 0.1 to about 0.4.

7. The negative electrode of claim 1, wherein:
a thickness of the second active material layer is greater than a thickness of the first active material layer; and
the thickness of the second active material layer is greater than a thickness of the third active material layer.

8. The negative electrode of claim 1, wherein:
the negative electrode active material layer comprises a first region and a second region adjacent to the first region;
the hole comprises a plurality of holes; and
a density of the plurality of holes in the first region is different from a density of the plurality of holes in the second region.

9. The negative electrode of claim 7, wherein:
the first region comprises a central area of the negative electrode active material layer;
the second region comprises a side area of the negative electrode active material layer; and
a density of the holes in the first region is greater a density of the holes in the second region.

10. The negative electrode of claim 1, wherein:
the negative electrode active material layer comprises a first region and a second region adjacent to the first region;
the hole comprises a first hole in the first region and a second hole in the second region; and
a depth of the first hole is different from a depth of the second hole.

11. The negative electrode of claim 9, wherein:
the first region comprises a central area of the negative electrode active material layer;
the second region comprises a side area of the negative electrode active material layer; and
a depth of the first hole is greater than a depth of the second hole.

12. The negative electrode of claim 1, wherein the hole is configured to allow the second active material layer to directly contact an electrolyte.

13. A negative electrode for a rechargeable lithium battery, the negative electrode comprising:
a negative electrode current collector; and
a negative electrode active material layer on the negative electrode current collector,
wherein the negative electrode active material layer comprises a first region and a second region adjacent to the first region,
wherein the first region comprises a plurality of first holes on a first portion of the first region,
wherein the second region comprises a plurality of second holes on a first portion of the second region, and
wherein a first pitch of the first holes is different from a second pitch of the second holes.

14. The negative electrode of claim 13, wherein a density of the first holes is different from a density of the second holes.

15. The negative electrode of claim 14, wherein a ratio of the first pitch to the second pitch is in a range of about 1.5 to about 10.

16. The negative electrode of claim 13, wherein a depth of at least one of the first holes is different from a depth of at least one of the second holes.

17. The negative electrode of claim 16, wherein a ratio of the first depth to the second depth is in a range of about 1.1 to about 2.

18. The negative electrode of claim 17, wherein a ratio of a first diameter of at least one of the first holes to a second diameter of at least one of the second holes is in a range of about 1.3 to about 4.

19. A rechargeable lithium battery, comprising:
the negative electrode as set forth in claim 1;
a positive electrode that comprises a positive electrode current collector and a positive electrode active material layer on the positive electrode current collector; and
a separator between the negative electrode and the positive electrode.

20. The rechargeable lithium battery of claim 19, wherein a hole defined on the negative electrode is adjacent to the separator.
